(19) United States
(12) Patent Application Publication
(10) Pub. No.: US 2003/0050930 A1
(43) Pub. Date: Mar. 13, 2003

(54) Method and apparatus for lockstep data replication

(76) Inventors: Malcolm Mosher JR., Los Gatos, CA (US); Charles Johnson, San Jose, CA (US); Ronald M. Cassou, Palo Alto, CA (US); David Hege, San Jose, CA (US)

Correspondence Address: Pennie & Edmonds, LLP, 3300 Hillview Avenue, Palo Alto, CA, 94304, US

(21) Appl. No.: 10/056,145

(22) Filed: Jan. 22, 2002

Related U.S. Application Data
(60) Provisional application No. 60/322,794, filed on Sep. 12, 2001.

(51) Int. Cl. G06F 7/00

(52) U.S. Cl. 707/9

(57) ABSTRACT

A remote data facility (RDF) capable of performing a lockstep data replication procedure (“LockStep Procedure”). When the LockStep Procedure is invoked, and when an application program has committed a transaction, the application program is prevented from executing other procedures until the application is notified that audit records associated with that transaction have been safely stored to the backup system. Since the application program is prevented from executing other procedures, no decision based on the commit will be made until after the application is notified that all the audit records associated with the transaction are safely stored in the backup system.

The present application claims priority under 35 U.S.C. § 119(e) to co-pending U.S. Provisional Application bearing serial No. 60/322,794, filed Sep. 12, 2001.

### RELATED APPLICATIONS

The present application is related to co-pending U.S. non-provisional patent application entitled bearing serial No. 09/883,066 and entitled “ULTRA-HIGH SPEED DATABASE REPLICATION WITH MULTIPLE AUDIT LOGS”, and co-pending U.S. non-provisional patent application bearing serial No. 09/883,067 and entitled “SYSTEM AND METHOD FOR PURGING DATABASE UPDATE IMAGE FILES AFTER COMPLETION OF ASSOCIATED TRANSACTIONS FOR A DATABASE REPLICATION SYSTEM WITH MULTIPLE AUDIT LOGS”. These patent applications are hereby incorporated by reference.

### BRIEF DESCRIPTION OF THE INVENTION

The present invention relates generally to database management systems having a primary database facility and a duplicate or backup database facility. More particularly, the present invention relates to system and method for ensuring that critical data is safely stored a remote backup database.

### BACKGROUND OF THE INVENTION

The present invention is an improvement on the “remote data facility” (RDF) technology disclosed in U.S. Pat. No. 5,740,433, U.S. Pat. No. 5,745,753, U.S. Pat. No. 5,794,252, U.S. Pat. No. 5,799,322, U.S. Pat. No. 5,799,323, U.S. Pat. No. 5,835,915, and U.S. Pat. No. 5,884,328, all of which are hereby incorporated by reference as background information.

Remote Data Facility (RDF) technology is primarily used for replicating and storing locally generated data at a remote backup site. While most operations of an RDF system are designed to be fail-safe, it is possible for a primary system to fail after it commits a transaction, but before the data associated with the committed transaction is sent to a backup system for remote data replication. The particular criticality of this scenario is that, if application decisions were made as a result of the commit, the loss of data could be catastrophic to one's database and one's business. For example, suppose a money transfer between two banks took place, and that transfer involved several million dollars. Assume that the sending bank's applications committed the transaction (e.g., updated the appropriated records in the database) and that the sending bank's applications notified the receiving bank about the transaction, and then the disaster took place before the transaction could be replicated to the sending bank's backup disaster recovery site. The backup disaster recovery site would not have any records of the transaction, and it would appear as if the transaction never took place. The sending bank may therefore incur significant liabilities.

### SUMMARY OF THE INVENTION

An embodiment of the present invention is a remote data duplication (RDF) system capable of performing a lock step data replication procedure (“LockStep Procedure”). When the LockStep Procedure is invoked, and when an application has committed a transaction, the application is prevented from executing other procedures until the application is notified that audit records associated with that transaction have been safely stored to the backup system. Since the application is prevented from executing other procedures, no decision based on the commit will be made until after the application is notified that all the audit records associated with the transaction are safely stored in the backup system.

In accordance with one embodiment of the present invention, the lockstep data replication procedure includes the following steps:

Application starts a transaction and performs database updates.

Application ends the transaction to commit the database updates.

Application calls a DoLockStep procedure. The DoLockStep procedure is a waited operation. That is, before the DoLockStep procedure ends, the application is prevented from executing other procedures.

The DoLockStep procedure communicates with a RDF Gateway and indicates to the RDF Gateway that the application has called a DoLockStep procedure.

The RDF Gateway starts a transaction against an special RDF LockStep File. In one embodiment, the RDF LockStep File is located on a database volume that is protected by a Master Audit Trail. Audit records associated with this transaction against the RDF LockStep File (“LockStep Audit Record”) will be flushed to the Master Audit Trail to be read by the Master Extractor.

The RDF Gateway communicates with the Master Extractor of the RDF system regarding this LockStep Transaction. In particular, the RDF Gateway communicates the Transaction ID of the LockStep Audit Record to the Master Extractor. The Master Extractor then stores the Transaction ID in an Extractor LockStep Data Structure. The Transaction ID of the LockStep Audit Record is stored as LockStep_Gateway_TID.

The Master Extractor reads the Master Audit Trail, packs the audit records into buffers, and sends the buffers to a remote backup system. When the Master Extractor reads the LockStep Audit Record from the Master Audit Trail, the Master Extractor stores the Transaction ID associated with the LockStep Audit Record in the Extractor LockStep Data Structure as LockStep_{—Audit}_TID. In addition, the Master Extractor stores the Audit Trail Position of the LockStep Audit Record in the Extractor LockStep Data Structure as LockStep_AT_Posn. The Master Extractor also sets a LS_FLUSH flag in the Message Buffer before it is sent to the remote backup system.

The Master Receiver in the remote backup system, upon receiving a Message Buffer with a set LS_FLUSH flag, ensures that the audit records in the buffer are safely stored (e.g., flushed to disk) before responding with a Safe Audit Trail Position (Safe_AT_Posn).

Upon receiving the Safe_AT_Posn, the Master Extractor compares it with the LockStep_AT_Posn of the LockStep Audit Record, and sets a LockStepSafe flag when the Safe_AT_Posn is higher than or equal to the LockStep_AT_Posn. The Master Extractor also compares the LockStep Audit_TID and the LockStep_Gateway_TID.

When the LockStepSafe flag is set, and when LockStep_Audit_TID matches LockStep_Gateway_TID, then it can be concluded that the LockStep Audit Record has been safely stored. This means that all audit records preceding the LockStep Audit Record have been received by the remote backup system. The Master Extractor then notifies the RDF Gateway that lockstep is done. The Master Extractor does not notify that RDF Gateway that lockstep is done until these two conditions are met.

The RDF Gateway returns the status of the LockStep Procedure to the DoLockstep procedure, which was called by the application. The status of the LockStep Procedure may be represented by three values: LockStepDone, LockStepDisabled and LockStepNotDone. LockStepDone is returned if RDF Gateway is notified that the lockstep update record has been safely stored. This means any audit generated prior to it has been safely stored. If the RDF Gateway is not present, LockStepNotDone is returned. LockStepDisabled is returned if the system administrator has determined to turn off LockStep to allow applications waiting for LockStep to go forward. The applications will then continue as if the LockStep procedure were done.

The DoLockStep procedure ends and returns the status of the LockStep Procedure (either LockStepDone, LockStepNotDone, LockStepDisabled) to the application. The application then makes decisions based on the outcome of the LockStep Procedure.

### BRIEF DESCRIPTION OF THE DRAWINGS

For a better understanding of the invention, reference should be made to the following detailed description taken in conjunction with the accompanying drawings, in which:

FIGS. 1A and 1B are block diagrams illustrating a database management system with a remote duplicate database facility in accordance with an embodiment of the present invention.

FIGS. 1C and 1D are block diagrams illustrating a primary computer system and a backup computer system implementing the database management system of FIGS. 1A and 1B.

FIGS. 2A and 2B depict data structures used by the extractors in accordance with an embodiment of the present invention.

FIG. 3 illustrates a graphical representation of a Master Audit Trail and two Auxiliary Audit Trails in accordance with an embodiment of the present invention.

FIG. 4 illustrates a graphical representation of a Master Image Trail and two Secondary Image Trails in accordance with an embodiment of the present invention.

FIG. 5 is a flow diagram illustrating a lockstep process in accordance with an embodiment of the present invention.

FIGS. 6-9 depict a flow diagram for process steps carried out by the Master Extractor in accordance with an embodiment of the present invention.

FIG. 10 depicts process steps carried out by the Master Receiver in accordance with an embodiment of the present invention.

FIG. 11 depicts an Extractor LockStep Data Structure according to one embodiment of the invention.

### DESCRIPTION OF THE PREFERRED EMBODIMENTS

Overview of RDF System

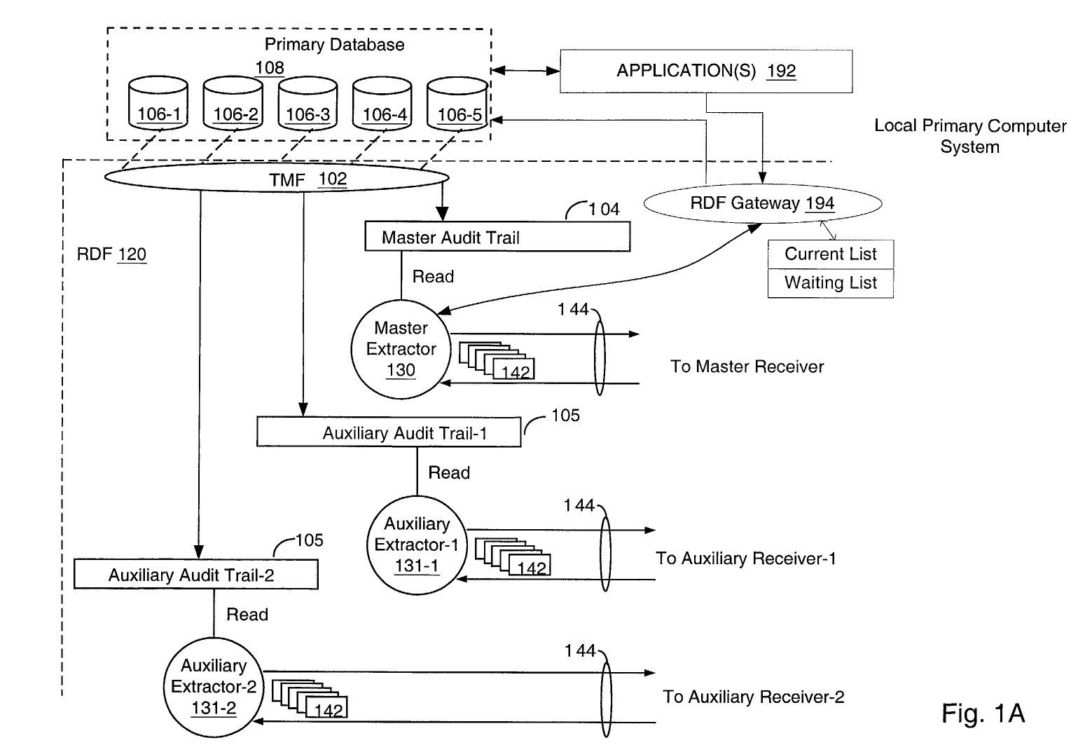

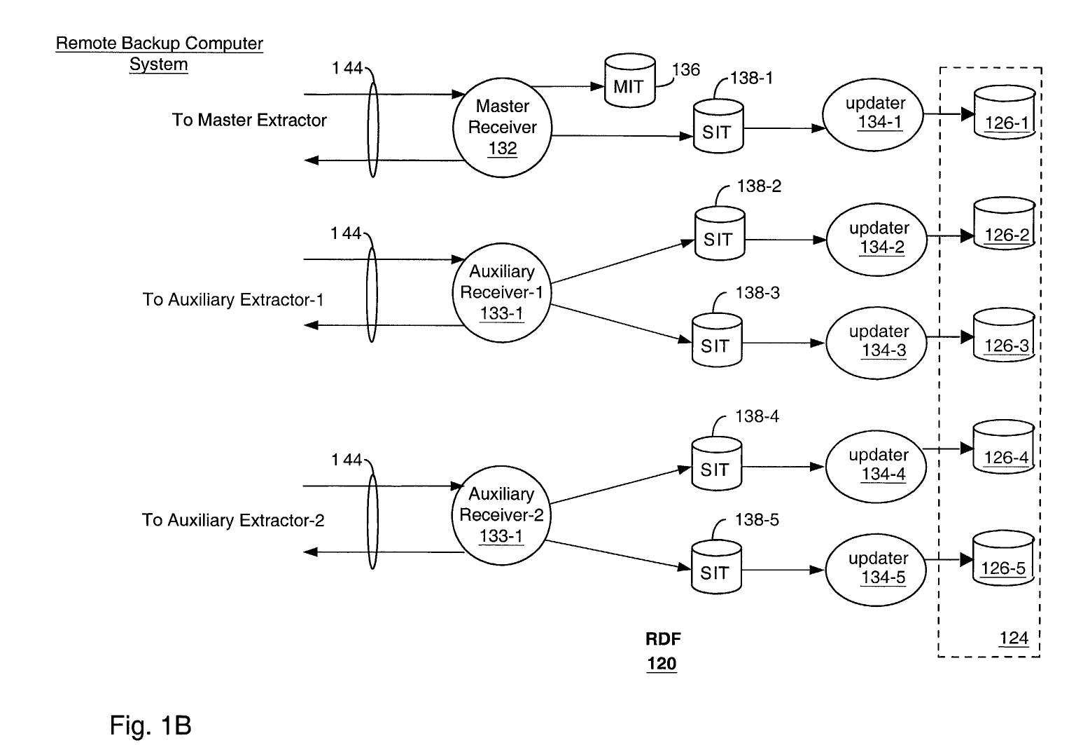

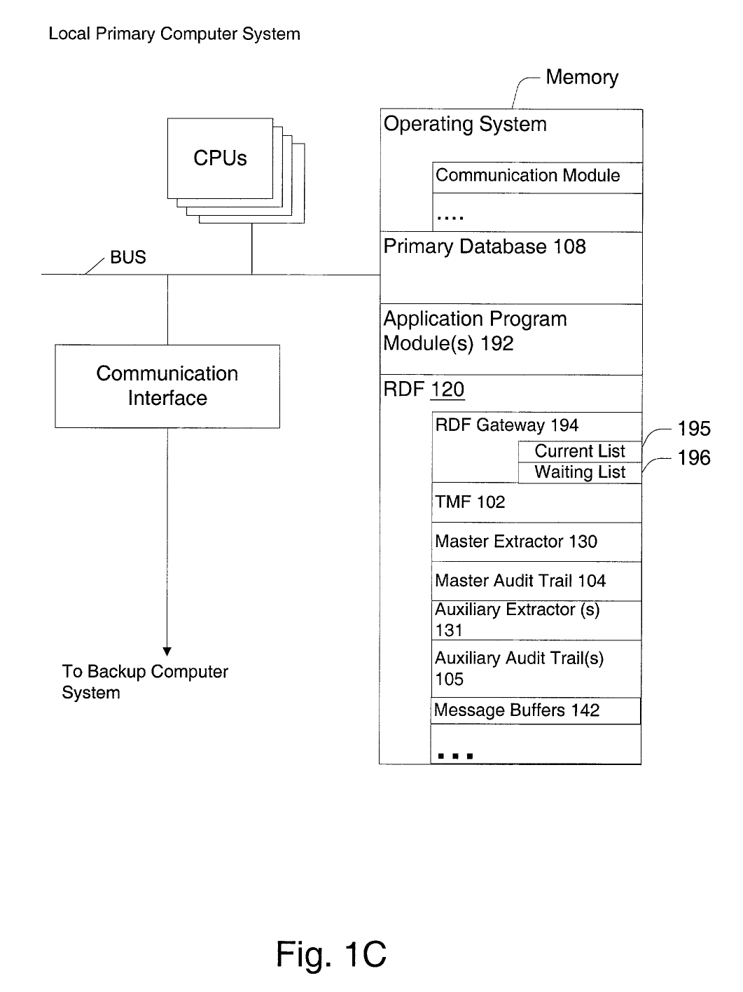

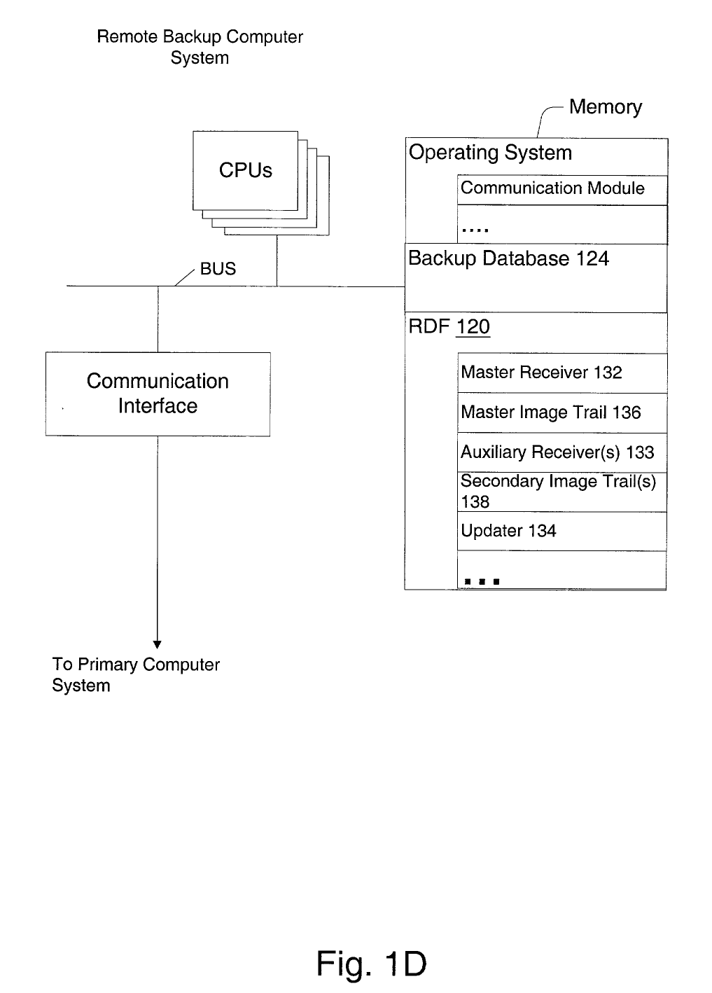

FIGS. 1A and 1B represent the basic architecture of an RDF system 120. In RDF system 120, each process has a respective local backup process that is automatically invoked if the primary process fails. Each local backup process is located on a different CPU than its respective primary process, and provides a first level of fault protection. A primary purpose of the RDF (remote data facility) system 120 is to handle failures in the primary system that cannot be resolved through the use of local backup processes (and other local remedial measures), such as a complete failure of the primary system.

FIG. 1A illustrates a portion of the RDF system 120 that resides on a local primary computer system. As shown, the RDF system 120 has a transaction management facility (TMF) 102 that writes audit entries to a master audit trail (MAT) 104 and to a plurality of auxiliary audit trails (AuxATs). The audit entries indicate changes made to “audited files” on “RDF protected volumes” 106 of a primary database 108 on the local primary computer system. Some RDF protected volumes are configured to write transaction audit records to the MAT 104, while some RDF protected volumes may be configured to write transaction audit records to the AuxATs 105. Changes made to the “audited files” are made by Application Program(s) 192 and a RDF Gateway 194.

FIG. 1B illustrates another portion of the RDF system 120 that resides on a remote backup computer system. The remote backup computer system may be geographically removed from the local primary computer system. In some embodiments, the local primary computer system and the remote backup computer system may be located on different continents. The RDF 120 maintains a replicated database 124 (also called the backup database) by monitoring changes made to “audited files” on “RDF protected volumes” 106 on a primary system and applying those changes to corresponding backup volumes 126 on the remote backup computer system. An “audited file” (sometimes called an “RDF audited file”) is a file for which RDF protection has been enabled, and an “RDF protected volume” is a logical or physical unit of disk storage for which RDF protection has been enabled.

On the local primary computer system, a Master Extractor 130 reads the master audit trail (MAT) 104, which is a log maintained by the transaction management facility (TMF) 102, and sends the audit records extracted from the MAT 104 to a Master Receiver 132 on the remote backup computer system. When the Master Extractor 130 extracts the audit records from the MAT 104, the Master Extractor 130 inserts Audit Trail Position (ATPosn) values into the audit records. Thus, the Master Receiver 132 receives audit records that contain the records' positions on the MAT 104.

The MAT 104 is stored as a series of files with sequentially numbered file names. The MAT files are all of a fixed size (configurable for each system), such as 64 Mbytes. The TMF 102 and Master Extractor 130 both are programmed to progress automatically (and independently) from one MAT file to the next.

If some RDF protected volumes are configured to write to Auxiliary Audit Trails 105 (AuxATs), Auxiliary Extractors 131 read the auxiliary audit trails 105, which are also audit logs maintained by the transaction management facility (TMF) 102. After extracting audit records from the AuxATs 105, the Auxiliary Extractors 131 insert in the audit records Audit Trail Position (ATPosn) values corresponding to the positions of the audit records in their respective AuxATs, and send the extracted audit records to Auxiliary Receivers 133 on the remote backup computer system. The Auxiliary Receivers 133 thus receive audit records of the AuxATs 105 that contain the records' positions on their respective AuxATs 105.

The RDF gateway 194 is a RDF process that sits between the Application Program(s) 192 and the Master Extractor 130. The RDF Gateway 194, in one embodiment, is responsive to LockStep Requests from the Application Program(s) 192. The RDF Gateway process 194 is also responsive to lockstep responses from the Master Extractor 130. Also shown in FIG. 1A are two lists of LockStep Requests maintained by the RDF Gateway 194. One of the lists is the Current List 195, which includes the LockStep Requests that are currently being processed. The other list is the Waiting List 196, which includes LockStep Requests received by the RDF Gateway after the current LockStep Transaction began. Details of the LockStep Procedure and the tasks performed by the RDF Gateway 194 will be discussed further below.

FIG. 1C illustrates the components of an local primary computer system in accordance with an embodiment of the present invention. As shown, the local primary computer system includes central processing units (CPUs), a communication interface for communicating with the remote backup computer system, a memory (which may include random access memory as well as disk storage and other storage media) and one or more buses for interconnecting the aforementioned elements of system.

Operations of the primary computer system are controlled primarily by control programs and application program(s) 194 that are executed by the system's CPUs. The programs and data structures stored in the memory may include:

an operating system that includes procedures for handling various basic system services and for performing hardware dependent tasks;

communication software, which may be a component of the operating system;

a primary database 108;

application program(s) 192 related to the database; and

components of the remote data facility (RDF) 120.

Components of the RDF 120 that reside on the local primary computer system include the following:

a RDF Gateway 194, which includes a Current List 195 and a Waiting List 196;

a TMF 102;

a Master Extractor 130;

a Master Audit Trail 104;

Auxiliary Extractor(s) 131;

Auxiliary Audit Trail(s) 105.

Components of the remote backup computer system, which are similar to those of the local primary computer system, are depicted in FIG. 1D. As shown, the remote backup computer system includes central processing units (CPUs), a communication interface for communicating with the local primary computer system, a memory (which may include random access memory as well as disk storage and other storage media) and one or more buses for interconnecting the aforementioned elements of system.

Operations of the remote backup computer system are controlled primarily by control programs that are executed by the system's CPUs. The programs and data structures stored in the memory of the remote backup computer system may include:

an operating system that includes procedures for handling various basic system services and for performing hardware dependent tasks;

communication software, which may be a component of the operating system;

a backup database 108; and

components of the remote data facility (RDF) 120.

Components of the RDF 120 that reside on the remote backup computer system include the following:

a Master Receiver 132;

a Master Image Trail 136;

Auxiliary Receiver(s) 133;

Secondary Image Trail(s) 105; and

Updaters 134.

Audit Trails Audit Record Types

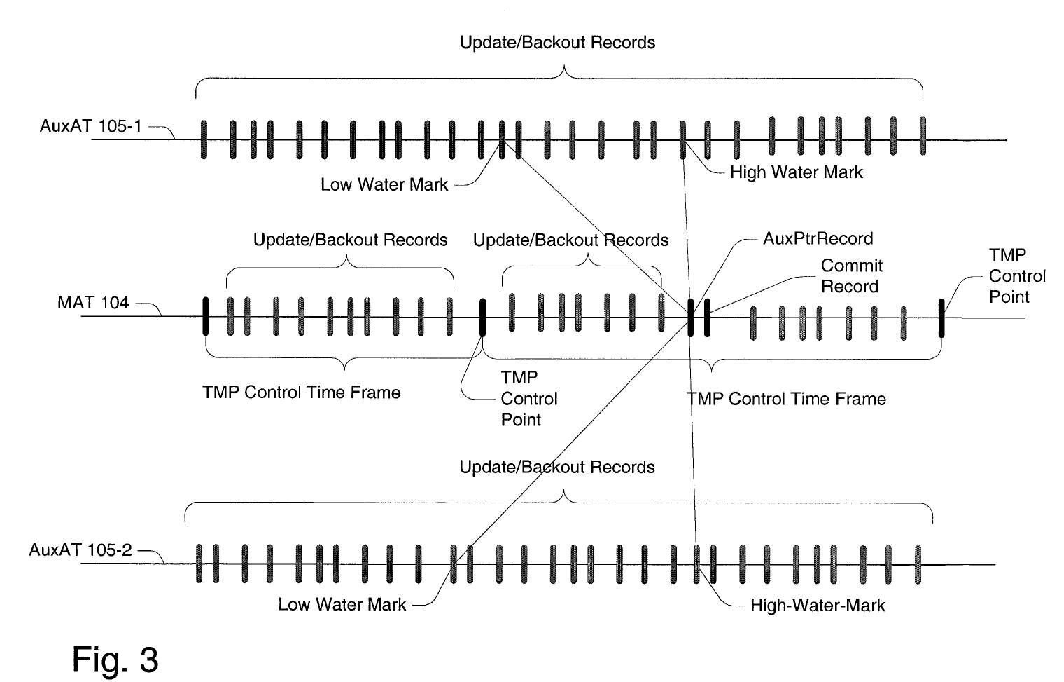

FIG. 3 is a graphical representation of the MAT 104 and two AuxATs 105. As shown, the master audit trail (MAT) 104 contains the following types of records:

Update records, which reflect changes to a database volume made by a transaction by providing before and after record images of the updated database record. Each update record indicates the transaction ID of the transaction that made the database change and the identity of the database volume and database record that has been updated.

Backout records, which reflect the reversal of previous changes made to a database volume on the primary system. The database changes represented by backout records are sometimes herein called update backouts and are indicated by before and after record images of the updated database record. Backout audit records are created when a transaction is aborted and the database changes made by the transaction need to be reversed. Each backout record indicates the transaction ID of the transaction that made the database change and the identity of the database volume and database record that has been modified by the update backout.

Transaction state records (or, transtate records), including commit and abort records and transaction active records. Commit and abort records indicate that a specified transaction has committed or aborted. Transaction active records (also sometimes called transaction alive records) indicate that a transaction is active. Each transaction state record indicates the transaction ID of the transaction whose state is being reported. Every active transaction is guaranteed to produce one transaction state record during each TMP control time frame (i.e., between successive TMP control points) other than the TMP control time frame in which the transaction began. A transaction active record is stored in the master audit trail if the transaction does not commit or abort during a TMP control time frame.

TMP control point records, which are “timing markers” inserted by the TMF 102 into the master audit trail at varying intervals depending on the system's transaction load. During heavy transaction loads, TMP control point records may be inserted less than a minute apart; at moderate transaction loads the average time between TMP control point records is about 5 minutes; and under very light loads the time between TMP control point records may be as long as a half hour. The set of audit records between two successive TMP control point records are said to fall within a “TMP control time frame”.

Auxiliary Pointer Records, which include a High-Water-Mark and a Low-Water-Mark for each of the Auxiliary Audit Trails 105. An Auxiliary Pointer Record indicates the range of audit records written to the Auxiliary Audit Trails 105 since the last Auxiliary Pointer Record was written to the MAT.

The MAT 104 further includes:

Stop Updaters records, which cause all Updaters to stop when they read this record in their image trails.

Other records not relevant to the present discussion.

The auxiliary audit trails (AuxAT) 105 contain the following types of records:

Update records, which reflect changes to a database volume made by a transaction by providing before and after record images of the updated database record. Each update record indicates the transaction ID of the transaction that made the database change and the identity of the database volume and database record that has been updated.

Backout records, which reflect the reversal of previous changes made to a database volume. The database changes represented by backout records are sometimes herein called update backouts and are indicated by before and after record images of the updated database record. Backout audit records are created when a transaction is aborted and the database changes made by the transaction need to be reversed. Each backout record indicates the transaction ID of the transaction that made the database change and the identity of the database volume and database record that has been modified by the update backout.

Other records not relevant to the present discussion.

The Extractors-Overview

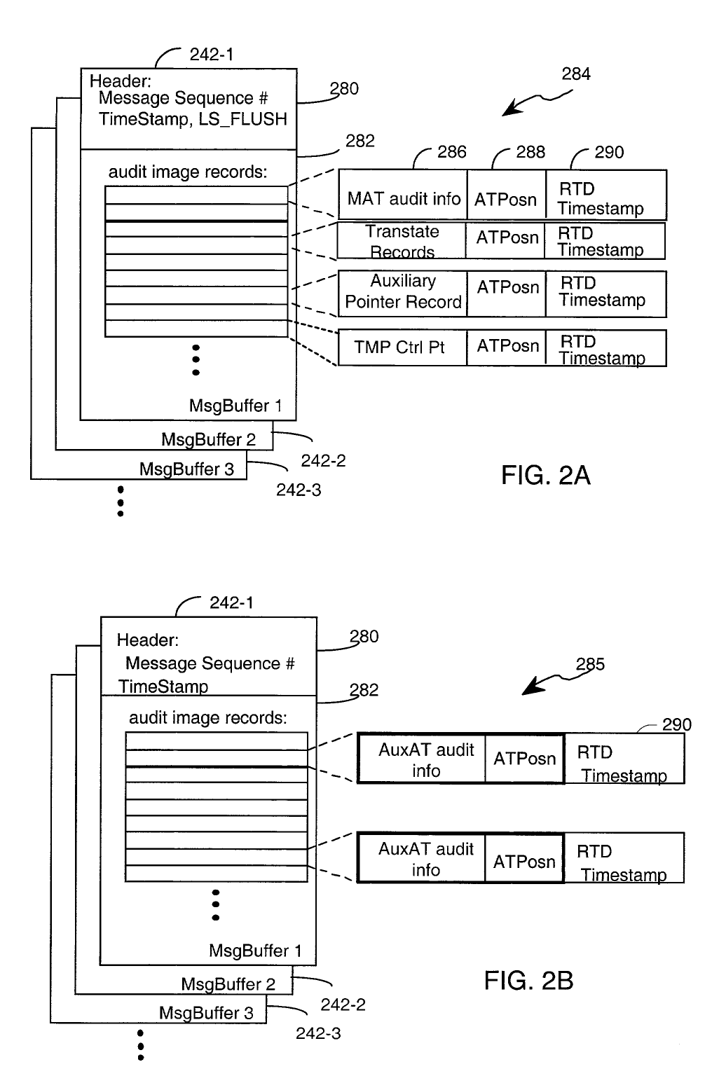

Referring to FIG. 2A, the Master Extractor 130 processes each Audit Record extracted from the MAT 104 by adding an Audit Trail Position value (ATPosn) 288 and a timestamp 290 thereto. The ATPosn value is the position of the extracted audit record in the MAT 104. The added timestamp 290 is known as the RTD timestamp, and is the timestamp of the last transaction to complete prior to generation of the audit record in the MAT 104. The resulting records are called audit image records 284. The Master Extractor 130 stores the audit image records in Message Buffers 242, each having a size of about 28K bytes in a preferred embodiment. Note that Message Buffers 242 for the MAT 104 contain control-type records such as Transaction State Records, TMP Control Point Records, etc., in addition to standard audit information (e.g., update records and backout records).

The Master Extractor 130 also stores information in the header of each Message Buffer. In the present embodiment, the Master Extractor 130 stores a LS_FLUSH flag in the header of each Message Buffer. This LS_FLUSH flag will be discussed below.

Referring to FIG. 2B, the Auxiliary Extractors 131 add an ATPosn value to each audit record that they extract from the AuxATs 105. A timestamp 290 is also added to each audit record. The resulting records are called auxiliary audit image records 285. The Auxiliary Extractors 131 store the auxiliary audit image records in Message Buffers 242. Note that, because the AuxATs 105 do not contain any transaction state records, TMP control point records or Auxiliary Pointer Records, the Auxiliary Extractors 131 do not send any such records to the backup system. Thus, the Message Buffers 242 for the AuxATs 105 do not contain control-type records. In a presently preferred embodiment, each Auxiliary Extractor 131 is associated with only one of the auxiliary audit trails 105 and vice versa.

Each one of the extractors 130, 131 uses two to eight Message Buffers 242, with four Message Buffers being a typical configuration. After filling and transmitting a Message Buffer 242 to the Master Receiver 132 via a communication channel 144 (FIG. 1), the Master Extractor 130 does not wait for an acknowledgment reply message from the Master Receiver 132. Rather, as long another Message Buffer is available, it continues processing audit records in the MAT 104, storing audit image records in the next available Message Buffer 242. Auxiliary Extractors 131 also transmit Message Buffers 242 to Auxiliary Receivers 133 in a similar manner. Each Message Buffer 242 is made unavailable after it is transmitted to the receivers 132 and 133 until a corresponding acknowledgment reply message is received from the receivers 132 and 133, at which point the Message Buffer 142 becomes available for use by the extractors 130 and 131.

The Receivers-Overview

Referring to FIGS. 1A and 1B, the Master Receiver 132, after receiving each Message Buffer, sends an acknowledgment to the corresponding Master Extractor 130. Similarly, each Auxiliary Receiver 133, after receiving a Message Buffer, sends an acknowledgment to the corresponding Auxiliary Extractor 131. The RDF system provides tight synchronization of the Extractors and Receivers and provides for automatic resynchronization whenever a start or restart condition occurs. For example, the two processes (i.e., an Extractor and the corresponding Receiver) will resynchronize whenever either process is restarted or has a primary process failure, and whenever the Receiver receives audit records out of order from the Extractor.

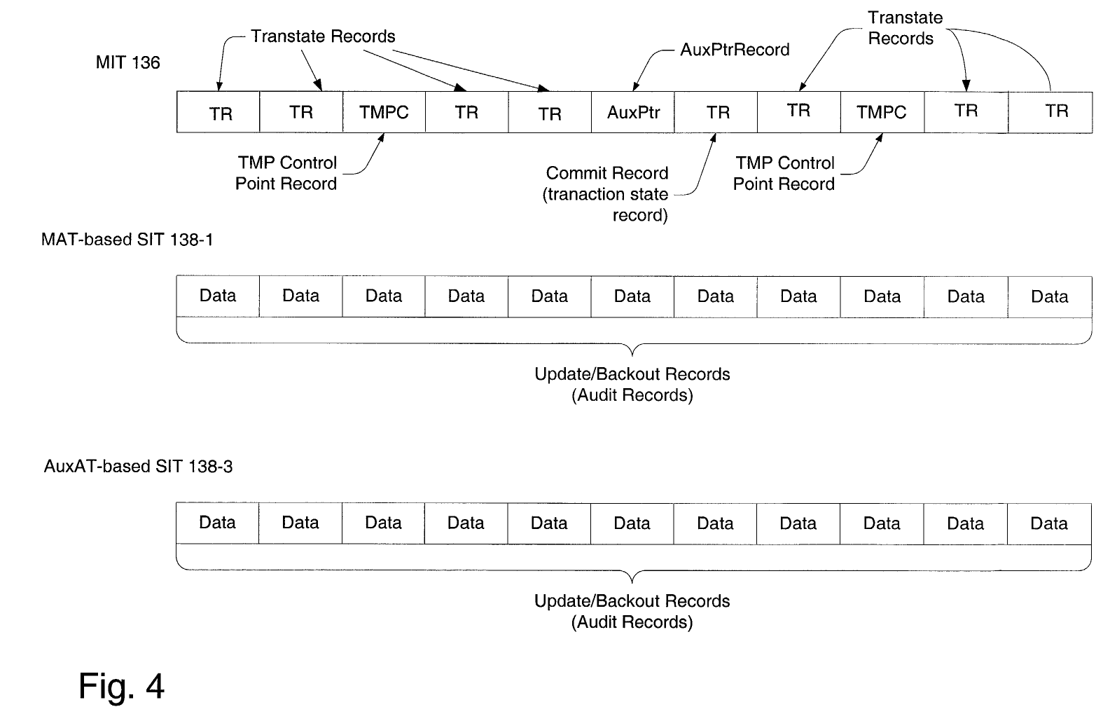

In a presently preferred embodiment, the Master Receiver 132 sorts received audit records from the MAT 104 such that (A) transaction state records (including commit/abort records), TMP control point records, and Auxiliary Pointer Records are stored only in the master image trail (MIT) 136, and (B) each database update and backout audit record is moved into one or more secondary image trails (SIT) 138. Note that in some embodiments, some control-type records may be stored in the SITs 138. The Auxiliary Receivers 133 sort received audit records from AuxATs 105 and distribute the audit records into one or more SITs 138. In the embodiment illustrated in FIG. 1B, each one of the SITs 138 corresponds to one Updater 134 that will use that audit record to update data stored on a backup volume 126. In some other embodiments, multiple Updaters 134 and multiple backup volumes 126 may be associated with a single SIT 138. A graphical representation of the MIT 136 and a SIT 138 is illustrated in FIG. 4. Note that the MIT 136 contains control-type audit records only.

The Master Receiver 132 examines the received Auxiliary Pointer Records, and maintains a table of current High-Water-Mark indicators for the Auxiliary Audit Trails. The Master Receiver 132 periodically sends the High-Water-Mark indicators to the corresponding Auxiliary Receivers. The Auxiliary Receivers then store the High-Water-Mark indicators for their auxiliary audit trails as the limit positions for the Updaters 134. Upon reaching the High-Water-Marks, the Auxiliary Receivers 133 may respond with acknowledgments to the Master Receiver 132.

Updaters—Overview

Each RDF-protected volume 106 on the primary computer system 110 has its own Updater 134 on the backup computer system 122 that is responsible for applying audit image records to the corresponding backup volume 126 on the backup computer system 122 so as to replicate the audit protected files on that volume. Audit image records associated with both committed and aborted transactions on the primary system are applied to the database on the remote backup computer system 122. In RDF system 120, no attempt is made to avoid applying aborted transactions to the backup database, because it has been determined that it is much more efficient to apply both the update and backout audit for such transactions than to force the updaters to wait until the outcome of each transaction is known before applying the transaction's updates to the backup database. By simply applying all logical audit to the backup database, the updaters are able to keep the backup database substantially synchronized with the primary database. Also, this technique avoids disruptions of the RDF system caused by long running transactions. In some RDF systems, long running transactions would cause the backup system to completely stop applying audit records to the backup database until such transactions completed.

Additional details of the Updaters and other processes (e.g., Extractors and TMF) may be found in above-mentioned patents and patent applications.

Lockstep Procedure

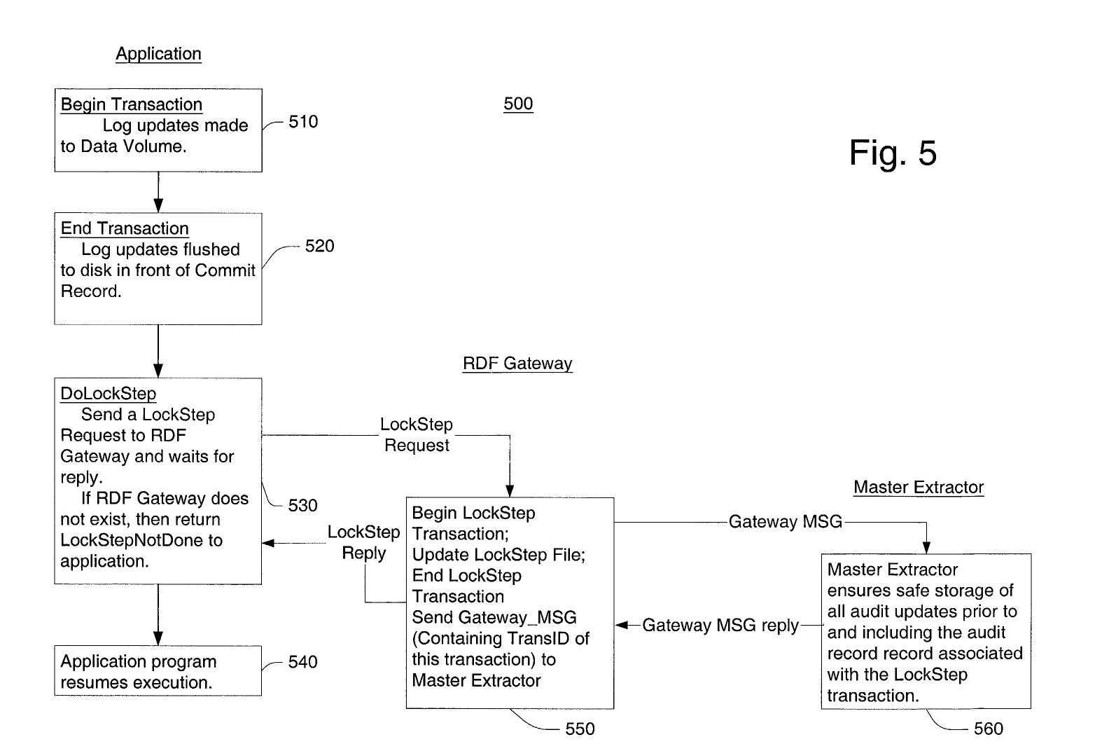

FIG. 5 is a diagram depicting the overall flow of a LockStep Procedure 500 in accordance with an embodiment of the present invention. Lockstep procedure 500 is performed mainly by three different processes in the local primary computer system. Namely, in the present embodiment, the processes are the application program (e.g., application program 192), the RDF Gateway (e.g., RDF Gateway 194), and the Master Extractor (e.g., Master Extractor 130). Some steps of the LockStep Procedure 500 are performed by the Master Receiver (e.g., Master Receiver 132) and the Transaction Management Facility (TMF) 102. In some embodiments, some steps of the LockStep Procedure 500 are performed by the Auxiliary Receivers 133.

With reference to FIG. 5, at step 510, lockstep data replication usually begins after the application program starts a transaction by calling a BeginTransaction procedure and updates RDF protected volumes (e.g., volumes 106). At the end of the transaction, at step 520, the application program calls an EndTransaction procedure, which flushes the updates to the Master Audit Trail (e.g., Master Audit Trail 105) and causes a commit record to be generated and stored in the Master Audit Trail. BeginTransaction and EndTransaction procedures are well known and are described in detail in the above referenced patents and patent applications.

After calling the EndTransaction procedure, the application program calls a DoLockStep procedure (step 530). In the present embodiment, the DoLockStep procedure sends a LockStep Request to the RDF Gateway. The DoLockStep procedure is a waited operation. That is, after calling the DoLockStep procedure, the application program pauses execution and waits for a reply from DoLockStep.

After the DoLockStep procedure is called, the procedure communicates a LockStep Request to a RDF Gateway, indicating to the RDF Gateway that the application program has called DoLockStep. Upon receiving the LockStep Request, the RDF Gateway begins a LockStep Transaction (step 550). In the present embodiment, a LockStep Transaction is a transaction started by the RDF Gateway against a special LockStepFile that is located on a RDF protected volume configured to the Master Audit Trail. This means that audit record(s) associated with the LockStep Transaction will be written to the Master Audit Trail by the Transaction Management Facility 102. Furthermore, the audit records associated with the LockStep Transaction (referred to herein as LockStep Audit Records) each include a Transaction ID that is associated with the corresponding LockStep Transaction. Each distinct Transaction ID is unique to a corresponding transaction in the RDF system. Thus, the Transaction ID can be used to uniquely identify a transaction.

In other embodiments of the invention, the LockStep Transaction does not write to the special LockStep File. In those embodiments, the LockStep Transaction may make a special call to the transaction monitoring process (e.g., TMF 102) such that an audit record with a special flag is generated. The special flag can be used to indicate to the Extractor that the audit record is a lockstep audit record.

In the present embodiment, the LockStepFile has a predetermined file name that is unique in the RDF system. Thus, all LockStep Transactions utilize this particular file. Furthermore, in the present embodiment, the Audit Records include the file name to which the update is associated. In other words, all LockStep Audit Records share the same file identifier.

In addition, at step 550, the RDF Gateway sends a Gateway Message (Gateway MSG) to the Master Extractor. In this embodiment, Gateway_MSG includes the Transaction ID of the LockStep Transaction.

At step 560, the Master Extractor receives the Gateway Message and performs operations to ensure the durable storage of all audit updates prior to and including the LockStep Audit Record(s). When the all audit updates prior to and including the LockStep Audit Record(s) are durably stored, the Master Extractor sends a Gateway Message Reply (Gateway_MSG_Reply) to the RDF Gateway. The Gateway_MSG_Reply will indicate to the RDF Gateway the status of the LockStep procedure. In response, the RDF Gateway sends a LockStep_Reply to the Application Program that called the DoLockStep procedure.

In the present embodiment, the reply from DoLockStep may be one of: LockStepDone, LockStepDisabled and LockStepNotDone. In the present embodiment, LockStepDone is returned when RDF Gateway receives the Gateway_MSG_Reply from the Extractor, which means that a LockStep Audit Record has been safely stored. This also means any audit generated prior to the lockstep update record has been safely stored. If the RDF Gateway does not exist (e.g., the process is unexpectedly terminated), or if the Application Program is unable to communicate with the RDF Gateway, DoLockStep returns LockStepNotDone. LockStepDisabled is returned if the system administrator has disabled LockStep operations to allow application programs waiting for LockStep to go forward. The application program will then continue as if the LockStep Procedures were done.

In the present embodiment, the RDF Gateway maintains two lists of LockStep Requests generated by the Application Programs. One of the lists is the Current List, which includes the LockStep Requests that are currently being processed. The other list is the Waiting List, which includes LockStep Requests received by the RDF Gateway after the current LockStep Transaction began. If the system administrator has disabled LockStep operations, all the LockStep Requests in the Current List and the Waiting List will immediately receive the LockStepDisabled Reply. New LockStep Requests arriving at the RDF Gateway after LockStep operations are disabled will not be put on either the Current List or the Waiting List. Rather, the new LockStep Requests will immediately receive a LockStepDisabled reply. LockStep operations, in the present embodiment, can also be re-enabled. Disabling and re-enabling LockStep operations can be achieved by sending appropriate messages to the RDF Gateway.

After the reply from DoLockStep is returned to the application program, DoLockStep ends, and the application program may resume execution of other procedures (step 540), including operations that depend upon the results of the transaction immediately preceding the call to the LockStep procedure. Such operations may include sending messages relating to the results of the prior transaction.

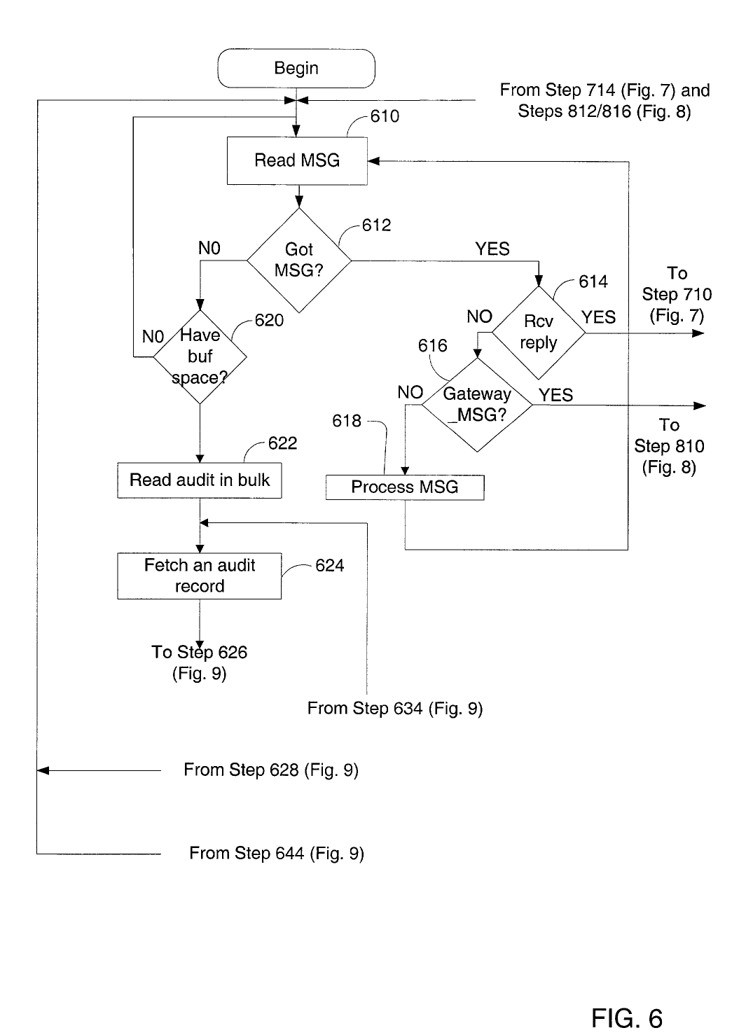

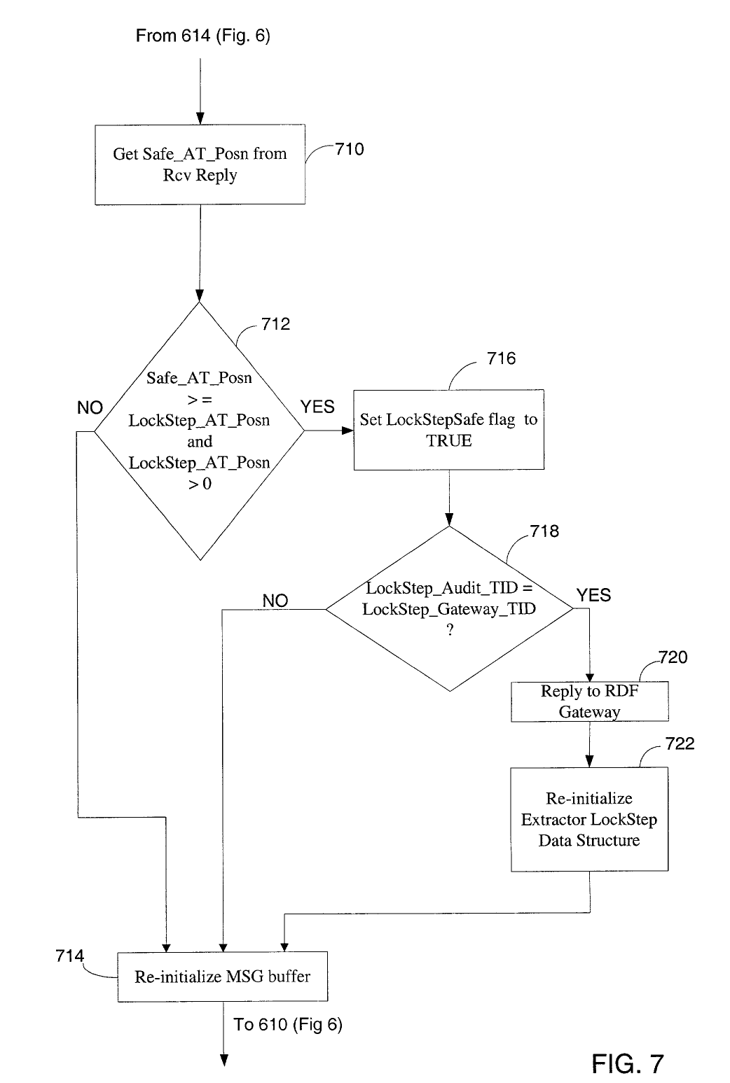

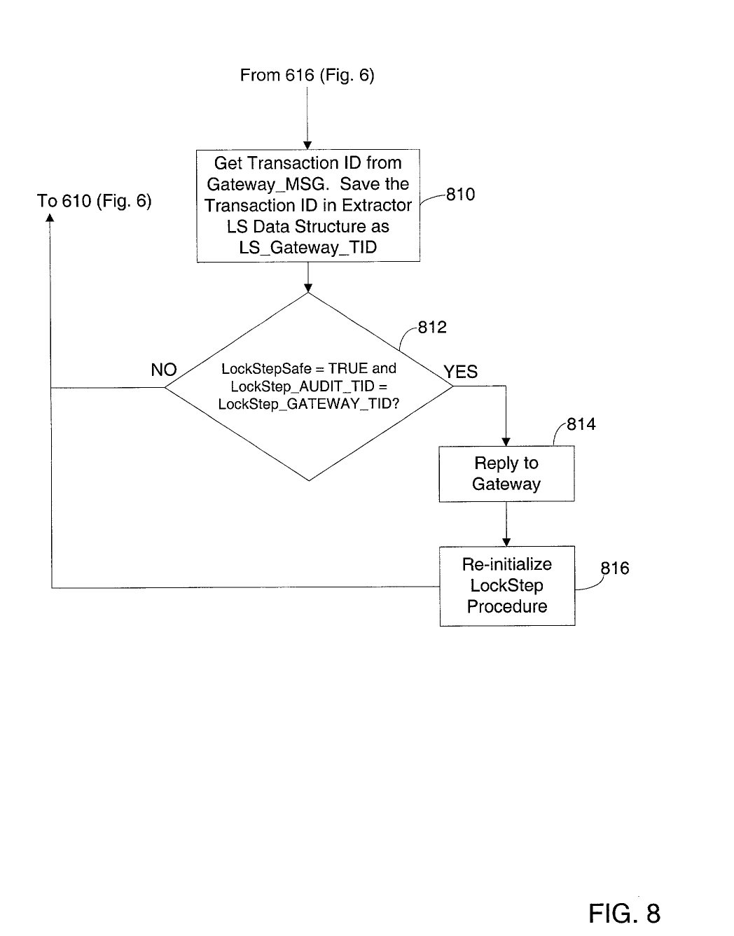

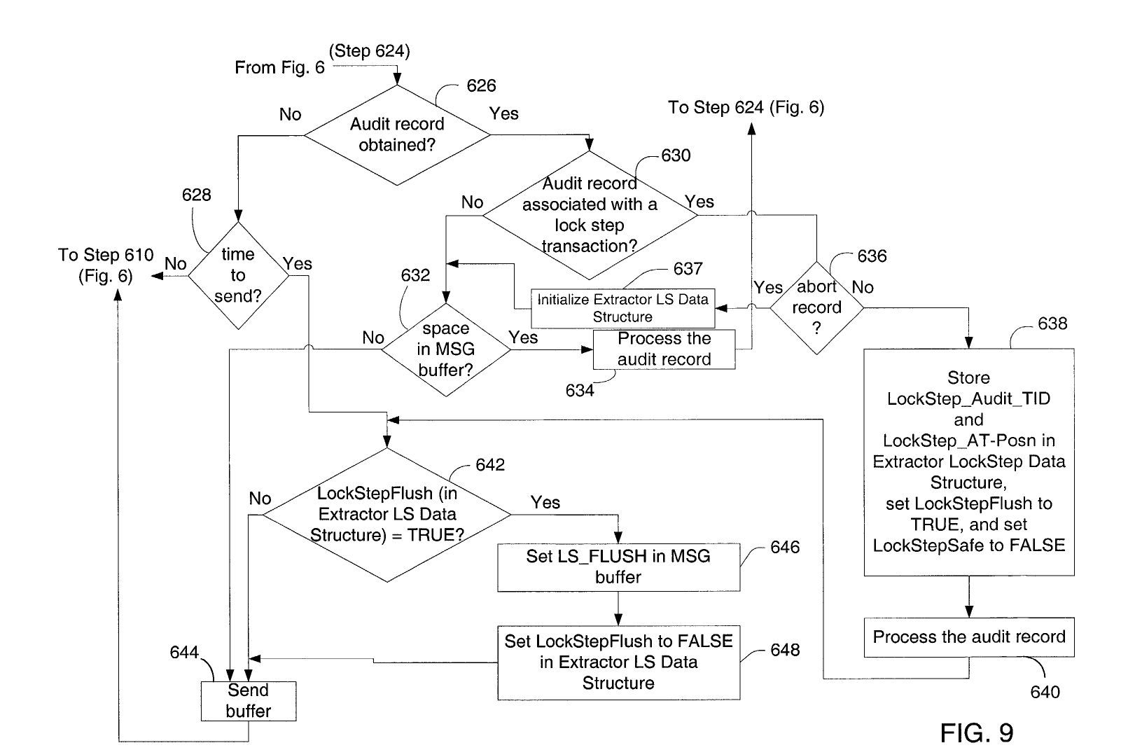

FIGS. 6-9 depict a detailed program flow for some of the operations of the Master Extractor when performing a LockStep procedure 500. With reference to FIG. 6, at step 610, the Master Extractor reads a Message Buffer, and determines whether the Message Buffer contains any messages (step 612). The messages that may be found in the Message Buffer includes Gateway Messages (Gateway_MSG), Receiver Replies, and other messages that are not relevant to the present invention.

If there is no message for the Master Extractor, it is then determined whether there is any buffer space for audit records (step 620). The Master Extractor, in the present embodiment, is configured to send audit records to the Master Receiver one Message Buffer at a time, where each Message Buffer has a predetermined size. If there is room in the Message Buffer for more audit records, then the Master Extractor reads audit records in bulk from the Master Audit Trail (step 622). Then, the Master Extractor attempts to fetch one of the audit records (step 624).

With reference to FIG. 9, the Master Extractor determines whether an audit record is obtained (step 626). If no audit record is obtained, then the Master Audit Trail has no new audit record. The Master Extractor then determines whether it is time to send the current Message Buffer to the Master Receiver (step 628). (Recall that Message Buffers are sent to the Master Receiver periodically.) If it is not yet time to send, the Master Extractor may attempt to retrieve more audit records. The Master Extractor may also perform other operations unrelated to the present invention until it is time to send the Message Buffer to the Master Receiver.

With reference still to FIG. 9, if it is determined that an audit record is obtained (step 626), then the Master Extractor determines whether the audit record is associated with a LockStep Transaction (step 630). That is, the Master Extractor determines whether the audit record is a LockStep Audit Record. In the present embodiment, the Master Extractor determines whether an audit record is a LockStep Audit Record by examining the file name associated with the audit record. As mentioned, in the present embodiment, all LockStep Transactions update against a special LockStepFile with a previously determined file name, and the name of the LockStepFile can be found in each LockStep Audit Record.

If it is determined that the audit record is not a LockStep Audit Record, then it is determined whether there is space in the Message Buffer (step 632). If not, then the Message Buffer is sent to the Master Receiver (step 644). The audit record is then re-read (step 610) and put into the next Message Buffer. If there is space in the current Message Buffer, then the audit record is processed such that it conforms with the format of the buffer (step 634).

If the audit record is a LockStep Audit Record, then it is determined whether the LockStep Audit Record is an abort update or an original update (step 636). If the LockStep Audit Record is an abort record, then it is processed as if it is a normal audit record. If the LockStep Audit Record is not an abort record, then the Master Extractor extracts the Transaction ID from the LockStep Audit Record and stores this information in a special Extractor LockStep Data Structure (step 638). Particularly, in this embodiment, the Master Extractor stores the Transaction ID as LockStep_Audit_TID in the Extractor LockStep Data Structure. In addition, the Master Extractor stores the Audit Trail Position of the LockStep Audit Record as LockStep_AT_Posn in the special LockStep Data Structure. In addition, at step 638, the Master Extractor sets a LockStepFlush flag in the Extractor LockStep Data Structure to TRUE, and sets a LockStepSafe flag in the Extractor LockStep Data Structure to FALSE.

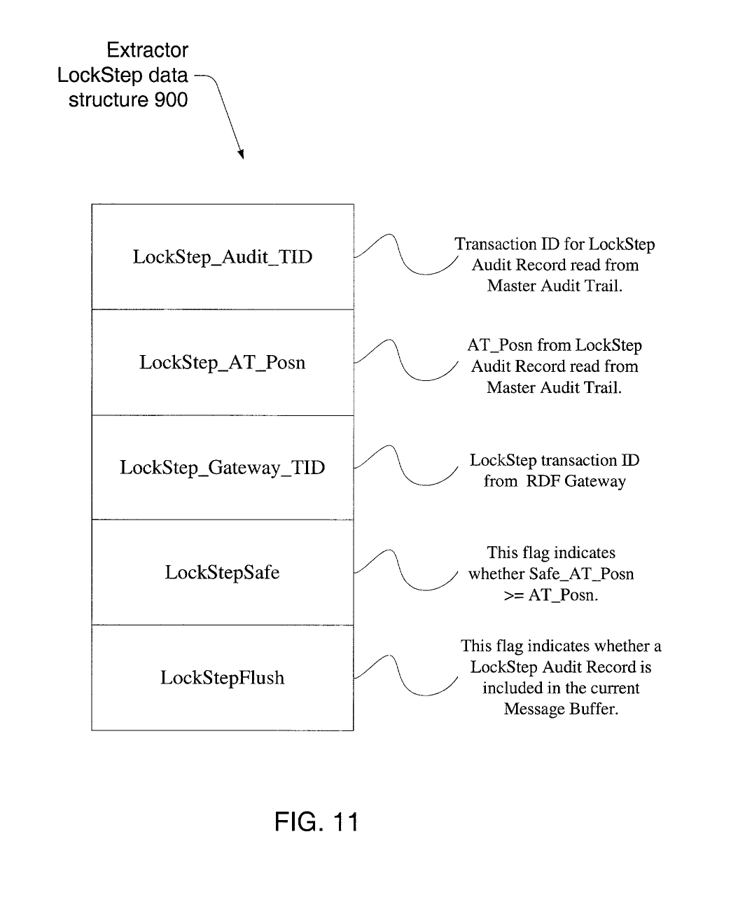

Referring to FIG. 11, the fields of the Extractor LockStep Data Structure 900 are as follows:

LockStep_Audit_TID, which is the Transaction ID extracted by the Master Extractor from the last LockStep audit record processed by the Master Extractor;

LockStep_AT_Posn, which indicates the position of the last LockStep audit record processed by the Master Extractor. In some embodiments, LockStep_AT_Posn may indicate the position of the last LockStep commit record processed by the Master Extractor;

LockStepFlush flag, which indicates that the Message Buffer contains at least one LockStep audit image record;

LockStep_Gateway_TID, which is the last Transaction ID received by the Master Extractor from the RDF Gateway, and thus represents the last LockStep transaction to have been initiated by the RDF Gateway; and

LockStepSafe flag, which is set to True only when the Master Receiver sends a message indicating that the AT_Posn of the last audit image record durably stored to disk in the backup system is at least as large as the LockStep_AT_Posn.

Referring back to FIG. 6, at step 640, the Master Extractor processes the LockStep Audit Record. As mentioned, the Master Extractor processes an audit record by adding its Audit Trail Position and a RTD timestamp thereto. The resulting record is also called an audit image record. The Master Extractor then places the audit image record in the current Message Buffer.

Then, at step 642, after having processed the LockStep Audit Record, the Master Extractor determines whether the LockStepFlush flag in the Extractor LockStep Data Structure is set to TRUE. If so, a LS_FLUSH flag in the header of the current Message Buffer is set to TRUE (step 646). After setting the LS_FLUSH flag to TRUE in the Message Buffer, the LockStepFlush flag in the Extractor LockStep Data Structure is reset to FALSE. Then, at step 644, the Master Extractor sends the Message Buffer containing the LockStep Audit Record and having a set LS_FLUSH flag to the Master Receiver. Note that, in the present embodiment, when a LockStep Audit Record is encountered by the Master Extractor, the LockStep Audit Record is immediately sent to the Master Receiver without regard to whether it is time to send or whether the Message Buffer is completely filled.

With reference again to FIG. 6, if is determined the Message Buffer contains a message (step 612), then it is determined whether the message is a Receiver Reply (step 614). If not, it is determined whether the message is a Gateway_MSG (step 616). If the message is neither a Receiver Reply nor a Gateway_MSG, the message could be of a type that is not related to the present invention. The message is then processed (step 618).

With reference now to FIG. 8, if it is determined that the message is a Gateway_MSG, the Master Extractor extracts the Transaction ID from the Gateway_MSG and stores the Transaction ID in the Extractor LockStep Data Structure in a field labeled LockStep_Gateway_TID (step 810). Recall that, in the present embodiment, the LockStep Transaction is initiated by the RDF Gateway, which also sends a Gateway_MSG containing the Transaction ID to the Master Extractor.

At step 812, the Master Extractor determines whether the LockStepSafe flag is set to TRUE and whether LockStep_Audit_TID matches LockStep_Gateway _TID. If these conditions are met, a LockStep Reply is immediately generated and communicated to the RDF Gateway (step 814). Then, the Extractor LockStep Data Structure is re-initialized (step 816). In one embodiment, when the Extractor LockStep Data Structure is re-initialized, its contents are reset to default values (e.g., zero, FALSE, etc.). If the conditions of step 812 are not met, the Master Extractor goes back to step 610.

In accordance with the present embodiment, in some situations it is possible that the Extractor reads the LockStep Audit Record before the RDF Gateway communicates the Gateway_MSG to the Extractor. These situations are taken into account by step 812, where a check is made to determine whether the newly received Gateway_MSG contains a transaction ID corresponding to a LockStep Audit Record that has already been safely stored in the remote backup computer system.

Attention now turns again to FIGS. 6 and 7. If it is determined that the Message Buffer contains a Receiver Reply (step 614), the Master Extractor retrieves a Safe_AT_Posn from the Receiver Reply (step 710). The Safe_AT_Posn value indicates the Audit Trail Position of the last audit record that has been durably stored in the remote backup system. Further discussion related to the generation of the Safe_AT_Posn value by the Master Receiver is found below.

At step 712, the Master Extractor compares the Safe_AT_Posn against the LockStep_AT_Posn value that is present in the Extractor LockStep Data Structure. If the Safe_AT_Posn value is larger than or equal to the LockStep_AT_Posn value, and if the Safe_AT_Posn is not equal to a predetermined initial value (e.g., zero), then it can be asserted that all the audit records prior to and including the LockStep Audit Record have been received by the Master Receiver. It can also be asserted that all the audit records prior to and including the LockStep Audit Record are durably stored in the backup computer system. Thus, at step 716, the LockStepSafe flag is set to TRUE.

But the fact that all the audit records prior to and including the LockStep Audit Record are safely stored is not sufficient to establish that the LockStep Procedure is complete. For instance, suppose the local primary computer system is somehow disrupted after a LockStep procedure has been called, and the LockStep procedure is terminated. Further, suppose the application program calls the LockStep procedure a second time. In this situation, the Master Extractor may receive a Safe_AT_Posn that is higher than the LockStep_AT_Posn corresponding to the first LockStep procedure, which is no longer active. A “LockStepDone” reply to the second LockStep procedure at this time may produce erroneous results.

Thus to avoid such erroneous results, at step 718, the Master Extractor determines whether the LockStep_Audit_TID (obtained from the last LockStep audit record read by the Master Extractor) matches the LockStep_Gateway_TID (obtained from the RDF Gateway and representing the last LockStep transaction to have been started by the RDF Gateway). If so, at step 720, the Master Extractor sends a LockStepDone reply to the RDF Gateway, and then LockStep data structure and message buffer are both re-initialized, at steps 722 and 714. Otherwise, if the LockStep_Audit_TID does not match the LockStep_Audit_TID (718-No), no reply message is sent to the RDF Gateway and instead the MSG buffer is re-initialized at step 714.

In this way, when the first LockStep procedure is terminated and when the second LockStep procedure is called, the second LockStep procedure's Transaction ID will be stored in the Extractor LockStep Data Structure as the LockStep_Gateway_TID, and a “LockStepDone” reply will not be made to the Gateway until the LockStep_Audit_TID matches the LockStep_Gateway_TID. The requirement that the LockStep_{—Gateway}_TID match the LockStep_Audit_TID guarantees synchronization between the RDF Gateway and the Extractor with respect to what has been safely stored. In other words, by checking that the Transaction IDS match at step 718, it can be ascertained that the LockStep Audit Record safely stored by the receiver corresponds to the same LockStep transaction that is called by the Application Programs).

It should be noted that when the LockStep Data Structure is re-initialized (e.g., step 722 or step 816), the values stored therein are reset to their default values. In one embodiment, the LockStep_Audit_TID, the LockStep_Gateway_TID, and the LockStep_AT_Posn may be reset to zero, and the LockStepSafe flag and LockStepFlush flags are reset to FALSE.

With reference still to FIG. 7, at step 714, the Master Extractor re-initializes the Message Buffer. The Message Buffer is re-initialized at this point because the contents of the Message Buffer are known to have been received by the backup computer system, and thus the contents of the Message Buffer are no longer needed (for retransmission to the backup computer system). The Master Extractor loops back to step 610 to read another message from the Message Buffer.

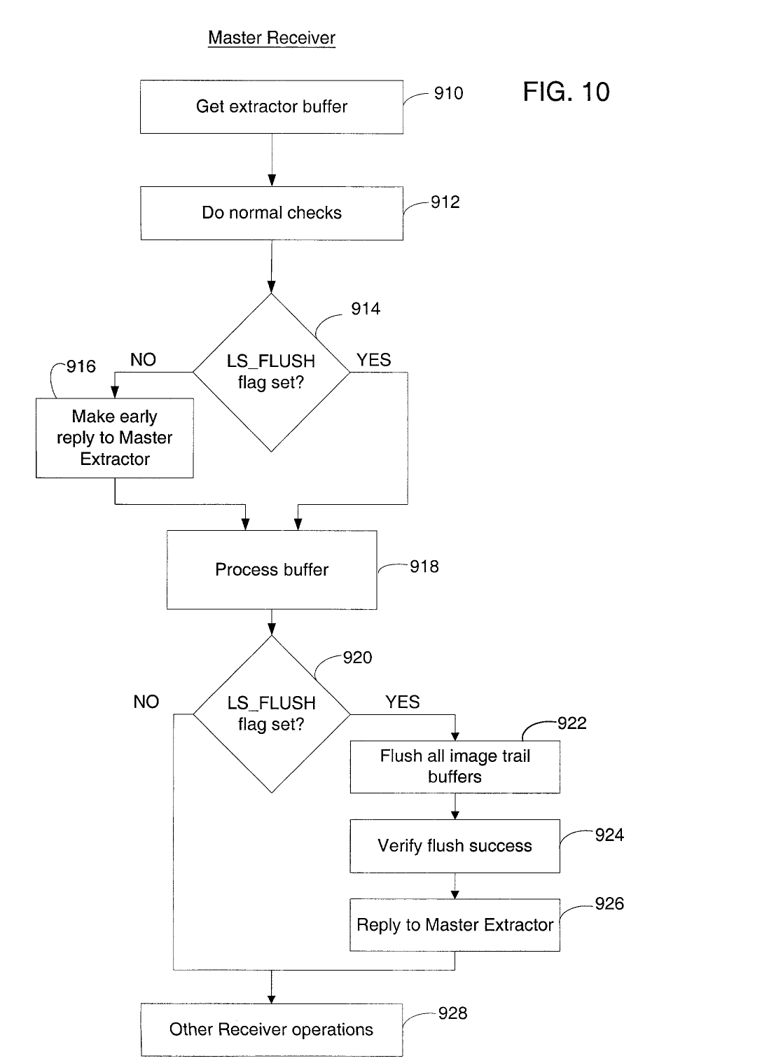

Attention now turns to FIG. 10, which depicts some operations of the Master Receiver when performing the LockStep procedure in accordance with an embodiment of the present invention. The Master Receiver first receives a Message Buffer (e.g., MsgBuffer 242) from the Master Extractor (step 910), and then perform various checks (e.g., integrity checks) on the Message Buffer (step 912). In additional to the normal checks, at step 914, the Master Receiver examines the header of the Message Buffer to determine if a LS_FLUSH flag is set. Recall that the Master Extractor sets the LS_FLUSH flag in the header of a Message Buffer when the Message Buffer contains a LockStep Audit Record. Thus, if the LS_FLUSH flag is not set, the Message Buffer does not contain a LockStep Audit Record. In this case, the Master Receiver can make an early reply to the Master Extractor, indicating that the Message Buffer has been received (step 916). In the present embodiment, the early reply to the Master Extractor includes the Audit Trail Position (ATPosn) of the last audit record that was durably stored. The Message Buffer is then processed (step 918). Note that, in previous versions of the RDF system that predate the present invention, and in the RDF system of the present embodiment, the early reply is the “normal” reply.

At step 928, the Master Receiver performs operations not unlike those performed by Master Receivers in previous versions of the RDF system. The audit records may be flushed to disks and durably stored at step 928.

If the LS_FLUSH flag is set, then the Message Buffer having the LS_FLUSH flag includes a LockStep Audit Record. In this case, an early reply is not made to the Master Extractor. Rather, the Message Buffer is processed (step 918), and then at step 920, it is determined again whether the LS_FLUSH flag is set. If so, the audit records in the Message Buffer are flushed to disks to be durably stored (step 922). After verifying that the flushes are successful (step 924), the Master Receiver then replies to the Master Extractor with the ATPosn of the audit record that has part been durably stored (step 926). In the present embodiment, the last audit record in a Message Buffer is always the LockStep Audit Record. (This is because the Message Buffer is sent immediately after a LockStep Audit Record is identified.) Thus, at step 926, the ATPosn of the LockStep Audit Record is returned as the Safe_AT_Posn.

Lockstep with Auxiliary Audit

In the embodiments discussed above, the LockStep Procedure is primarily concerned with audit records that are protected by the Master Audit Trail. In some embodiments of the present invention, it may be desirable to ensure that audit records in the Auxiliary Audit Trails are also durably stored. According to one of those embodiments, the Master Receiver may, before it makes a reply to the Master Extractor, look for an Auxiliary Pointer Record following the LockStep Audit Record. Recall that, an Auxiliary Pointer Record stores the High-Water-Mark for each Auxiliary Audit Trail (i.e., the ATPosn of the last audit record flushed to an Auxiliary Audit Trail). Also, in some embodiments with Auxiliary Audit Trails, an Auxiliary Pointer Record immediately precedes a Commit Record. Thus, in those embodiments, when the Master Receiver receives the Commit Record for the LockStep Transaction (LockStep Commit Record), the Master Receiver will have received the Auxiliary Pointer Record preceding the LockStep Commit Record. The Master Receiver then reads the High-Water-Marks stored in that preceding Auxiliary Pointer Record, sends waited messages including the High-Water-Marks to the Auxiliary Receivers, and waits until the Auxiliary Receivers reply with confirmations that audit records with ATPosns higher than or equal to the High-Water-Marks have been durably stored. When all the Auxiliary Receivers have made their replies, the Master Receiver then replies to the Master Extractor with the Safe_AT_Posn.

Note that, in one embodiment, the Master Receiver may have to reply to the Master Extractor with a “fake” Safe_AT_Posn before it has received the Auxiliary Pointer Record. This is because the LockStep Audit Record is typically the last audit record in a Message Buffer, and because the Master Extractor may not send a new Message Buffer unless the Master Receiver responds that it has received the current Message Buffer. The “fake” Safe_AT_Posn may be an old ATPosn (e.g., the previous Safe_AT_Posn), or a predetermined initial value (e.g., zero).

In accordance with another embodiment of the present invention, the Master Extractor may be configured to set the LS_FLUSH flag of a Message Buffer only when the Message Buffer contains a LockStep Commit Record. This embodiment can be achieved by slight modifications to the embodiments describe above. For example, step 636 may be modified to determine whether an audit record is a LockStep Commit Record. Steps 637 et seq. may be modified such that it is executed if the audit record is not a LockStep Commit Record, and steps 638 et seq. may be modified to such that it is executed if the audit record is a LockStep Commit Record. In this embodiment, when the Master Receiver receives the LockStep Commit Record, the Master Receiver will have received the preceding Auxiliary Pointer Record. The Master Receiver then reads the High-Water-Marks stored in that preceding Auxiliary Pointer Record, sends waited messages including the High-Water-Marks to the Auxiliary Receivers, and waits until the Auxiliary Receivers reply with confirmations that audit records with ATPosns higher than or equal to the High-Water-Marks have been durably stored. When all the Auxiliary Receivers have made their replies, the Master Receiver then replies to the Master Extractor with the Safe_AT_Posn. In this way, this embodiment may not be need to send any “fake” Safe_AT_Posn to the Master Receiver.

Multiple Concurrent LockStep Requests

Because DoLockstep suspends the application program that calls it until the LockStep Audit Record is durably stored on the backup system, a single application program cannot have more than one DoLockStep in progress at any single time. On the other hand, it is possible to have multiple application programs invoking DoLockstep concurrently. In such a situation, however, multiple LockStep Transactions do not take place concurrently. According to one embodiment of the invention, the RDF Gateway invokes a single LockStep Transaction to cover multiple application programs that called DoLockStep concurrently. When this single LockStep Transaction is done, LockStepDone is returned to the multiple application programs that called DoLockStep. Because the business transactions of each participating process must have committed before calling DoLockstep, the audit for the business transactions of the participating processes is guaranteed to be in the audit trail before the lockstep transaction starts. Thus, when the LockStep Audit Record of this LockStep Transaction is safe on the backup system, all audit records generated prior to the LockStep Audit Record are also guaranteed to be safe.

As mentioned above, in the present embodiment, the RDF Gateway may be configured to include a Current List and a Waiting List. When the RDF Gateway receives a LockStep Request, and if the Current List is empty, the RDF Gateway puts the LockStep Request in the Current List and immediately initiates a LockStep Transaction. When the LockStep Transaction is being executed, the RDF Gateway continues to accept new LockStep Requests, which will be put on the Waiting List. When the LockStep Transaction is done, (e.g., LockStepDone is returned), a reply is then made to the first LockStep Requestor, and the Current List is emptied. In addition, the LockStep Requests on the Waiting List are put on the Current List. LockStep Requests arriving thereafter are put on the Waiting List. In some embodiments, the RDF Gateway can be configured to collect LockStep Requests for up to a second before initiating a LockStep Transaction.

Alternate Embodiments

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Furthermore, it should be understood that the tasks performed by the Extractors, Receivers, Updaters, and the RDF Gateway of the preferred embodiments can, in other embodiments, be performed by processes performing other tasks as well, or by a different set of processes. Furthermore, in the embodiments described above, the primary computer system has a single RDF Gateway and a single RDF subsystem. In other embodiments, the primary computer system may have multiple RDF Gateways for multiple RDF subsystems.

The present invention can be implemented as a computer program product that includes a computer program mechanism embedded in a computer readable storage medium. For instance, the computer program product could contain the program modules for one or more of the Extractors, Receivers, Updaters, and Gateways. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

What is claimed is:

1. In a data replication system having a primary computer system and a backup computer system, a method of lock-step replication of database updates that occurred in the primary computer system to the backup computer system, the method comprising:
within a first application executing on the primary computer system:
performing and completing a first transaction on the primary computer system, the first transaction updating a first file in the primary computer system;
in the primary computer system, upon completing the first transaction, initiating a lockstep transaction that updates a second file in the primary computer system; and
waiting to receive a predefined message prior to performing any further operations;
sending audit records from the primary computer system to the backup computer system, the sent audit records including audit records representing the updates to the first file by the first transaction and the updates to the second file by the lockstep transaction;
receiving from the backup computer system confirmation that the audit records representing the updates to the first file by the first transaction and the updates to the second file by the lockstep transaction have been durably stored by the backup computer system, and upon receiving said confirmation, sending the predefined message to the first application.

2. The method of claim 1 wherein the lockstep transaction is initiated by a procedure call made immediately upon completion of the first transaction.

3. The method of claim 1 wherein the first application performs an operation dependent upon completion of the first transaction only after receiving the first predefined message.

4. The method of claim 1 further comprising:
upon occurrence of a pre-determined event that terminates the lockstep transaction, initiating a second lockstep transaction that updates the second file in the primary computer system;
after the second lockstep transaction is initiated, sending audit records from the primary computer system to the backup computer system, the sent audit records including audit records representing the updates to the second file by the another lockstep transaction;
after the second lockstep transaction is initiated, ignoring said confirmation that the audit records representing the updates to the first file by the first transaction and the updates to the second file by the lockstep transaction have been durably stored by the backup computer system;
after the second lockstep transaction is initiated, receiving a second confirmation that the audit records representing the updates to the second file by the second lockstep transaction have been durably stored by the backup computer system, and upon receiving said second confirmation, sending the predefined message to the first application.

5. In a data replication system having a primary computer system and a backup computer system, a method of lock-step replication of database updates that occurred in the primary computer system to the backup computer system, the method comprising:
initiating a lockstep transaction;
generating a lockstep audit record corresponding to the lockstep transaction, the lockstep audit record having a first transaction identifier;
storing the lockstep audit record in an audit trail;
reading audit records stored in the audit trail in a sequence in which the audit records are stored;
transmitting the audit records to the backup computer system, wherein the backup computer system includes mechanism for safely storing the lockstep audit record and audit records preceding the lockstep audit record immediately upon receiving the lockstep audit record, the backup computer system further including mechanisms for transmitting a safe audit trail position of the lockstep audit record to the primary computer system after the lockstep audit record is safely stored;
receiving the safe audit trail position from the backup computer system;
checking whether the safe audit trail position corresponds to a lockstep transaction that is currently active; and
based on results of the checking step, indicating completion of the lockstep replication procedure.

6. The method of claim 5, further comprising:
storing the first transaction identifier at a first location of a pre-defined data structure; and
during the reading step and upon encountering the first lockstep audit record, extracting an audit trail position and a transaction identifier from the first lockstep audit record;
storing the extracted audit trail position at a second location of the pre-defined data structure; and
storing the extracted transaction identifier at a third location of the pre-defined data structure.

7. The method of claim 6, wherein the checking step comprises:
comparing the safe audit trail position to the audit trail position stored at the second location; and
comparing the transaction identifier stored at the first location and the transaction identifier stored at the third location.

8. The method of claim 7, further comprising:
upon occurrence of an event that disrupts the lockstep replication procedure before completion, performing another lockstep transaction, the another lockstep transaction having a new transaction identifier; and
storing the new transaction identifier in the first location of pre-defined data structure such that the checking step results in a mismatch between the transaction identifier stored at the first location and the transaction identifier stored at the third location.

9. The method of claim 5, further comprising:
pausing execution of an application program upon initiation of the lockstep replication procedure; and
resuming execution of the application program upon completion of the lockstep replication procedure.

10. The method of claim 5, wherein the transmitting step comprises transmitting at least a subset of the audit records to the backup computer system in a message buffer, and wherein the backup computer system is configured to return an audit trail position of a last saved audit record as the safe audit trail position without ensuring the audit records of the message buffer are durably stored unless the lockstep audit record is included in the message buffer.

11. In a data replication system having a primary computer system and a backup computer system, a method of lock-step replication of database updates that occurred in the primary computer system to the backup computer system, the method comprising:
initiating a first lockstep replication procedure and performing a first update on a pre-determined file in the primary system, the first update being identified by a first unique transaction identifier;
storing the first unique transaction identifier in a pre-defined data structure in the primary system as a lockstep gateway transaction identifier (LockStep_Gateway_TID);
generating audit records that indicate database updates pertaining to database transactions performed on the primary system, the audit records further including a first lockstep audit record that is associated with the first update on the pre-determined file and that includes the first unique transaction identifier;
storing the audit records in an audit trail in the primary system;
extracting audit records from the audit trail for transmission to the backup computer system;
storing an audit trail position of the first update in the pre-defined data structure upon encountering the first lockstep audit record during the extracting step;
storing the first unique transaction identifier in the pre-defined data structure as a lockstep audit transaction identifier (LockStep_Audit_TID) upon encountering the first lockstep audit record during the extracting step;
transmitting the stream of audit records and a lock-step indicator to the backup computer system, wherein the lock-step indicator indicates a lockstep replication procedure has initiated, wherein the backup computer system is configured to ensure the stream of audit records are durably stored upon receiving the lock-step indicator, and wherein the backup computer system is configured to transmit to the primary computer system a safe position indicating the audit trail position of durably stored audit records upon receiving the lock-step indicator;
comparing the safe position returned by the backup computer system to the audit trail position stored in the pre-defined data structure; and
indicating completion of the lockstep replication procedure when the safe position is equal to or higher than the audit trail position stored in the pre-defined data structure, and when the lockstep gateway transaction identifier (LockStep Gateway_TID) matches the lockstep audit transaction identifier (LockStep_Audit_TID).

12. The method of claim 11, further comprising:
pausing execution of an application program upon initiation of the lockstep replication procedure; and
resuming execution of the application program upon completion of the lockstep replication procedure.

13. The method of claim 11, further comprising:
upon occurrence of an event that disrupts the first lockstep replication procedure before completion, performing a second update on the predetermined file in the primary system, the second update being identified by a second unique transaction identifier;
storing the second unique transaction identifier in the pre-defined data structure as the lockstep gateway transaction identifier (LockStep_Gateway_TID) in place of the first unique transaction identifier.

14. The method of claim 11, wherein the transmitting step comprises transmitting the stream of audit records to the backup computer system one buffer at a time, and wherein the backup computer system is configured to return an audit trail position of a last saved audit record as the safe position without ensuring the audit records of the buffer are durably stored unless the lockstep indicator is included in the buffer.

15. In a data replication system having a primary computer system and a backup computer system, a method of lock-step replication of database updates that occurred in the primary computer system to the backup computer system, the process comprising:
starting a lockstep replication procedure;
performing a first update on a predetermined file in the primary system, the first update being identified by a first unique transaction identifier;
storing the first unique transaction identifier in a pre-defined data structure in the primary system as a lockstep gateway transaction identifier (LockStep_Gateway_TID);
generating audit records that indicate database updates pertaining to database transactions performed on the primary system, the audit records further including a first lockstep audit record that is associated with the first update on the pre-determined file and that includes the first unique transaction identifier;
storing the audit records in an audit trail in the primary system;
upon an occurrence of an event that disrupts operations of the primary computer system, performing the steps of:
performing a second update on the pre-determined file in the primary system, the second update being identified by a second unique transaction identifier,
replacing the first unique transaction identifier with the second unique transaction identifier in the pre-defined data structure,
generating a second lockstep audit record that is associated with the second update on the pre-determined file and that includes the second unique transaction identifier,
storing the second lockstep audit record in the audit trail;
extracting audit records from the audit trail for transmission to the backup computer system;
concurrently with the extracting step, storing audit trail position of the first lock step audit record in the pre-defined data structure upon encountering the first lockstep audit record and replacing the stored audit trail position with the audit trail position of the second lock step audit record upon encountering the second lockstep audit record;
concurrently with the extracting step, storing the first unique transaction identifier in the pre-defined data structure as a lockstep audit transaction identifier (LockStep_Audit_TID) upon encountering the first lockstep audit record and replacing the stored lockstep audit transaction identifier with the second unique transaction identifier upon encountering the second lockstep audit record;
transmitting the stream of audit records and a lock-step indicator to the backup computer system, wherein the lock-step indicator indicates a lockstep replication procedure has initiated, wherein the backup computer system is configured to ensure the stream of audit records are durably stored upon receiving the lock-step indicator, and wherein the backup computer system is configured to transmit to the primary computer system a safe position indicating the audit trail position of durably stored audit records upon receiving the lock-step indicator;
comparing the safe position returned by the backup computer system to the audit trail position stored in the pre-defined data structure; and
indicating completion of the lockstep replication procedure when the safe position is equal to or higher than the audit trail position stored in the pre-defined data structure, and when the lockstep gateway transaction identifier (LockStep_Gateway_TID) matches the lockstep audit transaction identifier (LockStep_Audit_TID).

16. The method of claim 15, further comprising:
pausing execution of an application program upon starting the lockstep replication procedure; and
resuming execution of the application program upon completion of the lockstep replication procedure.

17. The method of claim 15, wherein the transmitting step comprises transmitting the stream of audit records to the backup computer system one buffer at a time, and wherein the backup computer system is configured to return an audit trail position of a last saved audit record as the safe position without ensuring the audit records of the buffer are durably stored unless the lockstep indicator is included in the buffer.

18. A database replication system having a primary computer system and a backup computer system, the primary computer system configured to couple to a database, the primary computer system having an application program that performs database transactions on the database, the database replication system comprising:
a gateway configured to initiate a lockstep replication procedure and perform a first update on a pre-determined file in the database upon receiving a lockstep request from the application program, wherein the first update is identified by a first unique transaction identifier;
a TMF module configured to generate audit records that indicate database updates pertaining to database transactions performed on the primary system, wherein the audit records further include a first lockstep audit record that is associated with the first update on the pre-determined file and that includes the first unique transaction identifier, the TMF module further configured to store the audit records in an audit trail in the primary system;
an extractor configured to extract audit records from the audit trail for transmission to the backup computer system;
the extractor configured to store the first unique transaction identifier received from the gateway process in a pre-defined data structure in the primary system as a lockstep gateway transaction identifier (LockStep_Gateway_TID);
the extractor configured to store an audit trail position of the first update in the pre-defined data structure upon encountering the first lockstep audit record in the audit trail;
the extractor configured to store the first unique transaction identifier in the pre-defined data structure as a lockstep audit transaction identifier (LockStep_Audit_TID) upon encountering the first lockstep audit record in the audit trail;
the extractor configured to transmit the stream of audit records and a lock-step indicator to the backup computer system, wherein the lock-step indicator indicates a lockstep replication procedure has initiated, wherein the backup computer system is configured to ensure the stream of audit records are durably stored upon receiving the lock-step indicator, and wherein the backup computer system is configured to transmit to the extractor a safe position indicating the audit trail position of durably stored audit records upon receiving the lock-step indicator;
the extractor configured to compare the safe position returned by the backup computer system to the audit trail position stored in the pre-defined data structure;
the extractor configured to communicate to the gateway a status of the lockstep replication procedure when the safe position is equal to or higher than the audit trail position stored in the pre-defined data structure, and when the lockstep gateway transaction identifier (LockStep_Gateway_TID) matches the lockstep audit transaction identifier (LockStep_Audit_TID); and
the gateway configured to generate a response to the lockstep request according to the status of the lockstep replication procedure.

19. The data replication system of claim 18, wherein execution of the application program pauses upon initialization of the lockstep replication procedure and wherein execution of the application program is configured to resume upon completion of the lockstep replication procedure.

20. The data replication system of claim 18, wherein the gateway is configured to perform a second update on the pre-determined file in the primary system upon occurrence of an event that disrupts the first lockstep replication procedure before completion, the second update being identified by a second unique transaction identifier.

21. The data replication system of claim 20, wherein the gateway is configured to replace the second unique transaction identifier in the pre-defined data structure as the lockstep gateway transaction identifier (LockStep_Gateway_TID) in place of the first unique transaction identifier.

22. The data replication system of claim 18, wherein the extractor transmits the stream of audit records to the backup computer system one buffer at a time, and wherein the backup computer system is configured to return an audit trail position of a last saved audit record as the safe position without ensuring the audit records of the buffer are durably stored unless the lockstep indicator is included in the buffer.
